(19) United States
(12) Patent Application Publication
(10) Pub. No.: US 2020/0047623 A1
(43) Pub. Date: Feb. 13, 2020

(54) VEHICLE CHARGING SYSTEM OBJECT DETECTION SYSTEMS AND METHODS

(71) Applicant: Ford Global Technologies, LLC, Dearborn, MI (US)

(72) Inventors: Mateusz ZADROZNY, Macomb, MI (US); Christopher W. BELL, Livonia, MI (US)

(21) Appl. No.: 16/101,823

(22) Filed: Aug. 13, 2018

(51) Int. Cl. B60L 11/18; H02J 50/10; H02J 50/60; H02J 50/90

(52) U.S. Cl. CPC B60L 11/1833; B60L 11/182; B60L 11/1829; B60L 11/1838; B60L 2250/16; H02J 50/60; H02J 50/90; B60L 2230/16; H02J 50/10

(57) ABSTRACT

A vehicle includes a charge plate configured to receive charge for a battery when positioned at a charge zone. The vehicle also includes a camera system and a controller programmed to cause the camera system to capture a calibration image at each of a plurality of indexed positions as the charge plate approaches the charge zone. The controller is also programmed to cause the camera system to capture a present image for at least one of the indexed positions, and prevent initiation of a charge procedure responsive to differences between the present image and a corresponding one of the calibration images exceeding a pixel variance threshold.

### TECHNICAL FIELD

This disclosure relates to the recharging of vehicle batteries.

### BACKGROUND

Charging methods for electrified vehicles having an electric storage device have increased in prevalence as advancements in vehicle propulsion and battery technology have occurred. Induction charging may be convenient to vehicle users since no direct physical connection is required between the charge source and the battery. However, a charging gap between a primary induction charging plate and a secondary induction charging plate may allow for the entry of foreign objects into the field of charge.

### SUMMARY

A vehicle includes a charge plate configured to receive charge for a battery when positioned at a charge zone. The vehicle also includes a camera system and a controller programmed to cause the camera system to capture a calibration image at each of a plurality of indexed positions as the charge plate approaches the charge zone. The controller is also programmed to cause the camera system to capture a present image for at least one of the indexed positions and prevent initiation of a charge procedure responsive to differences between the present image and a corresponding one of the calibration images exceeding a pixel variance threshold.

A vehicle battery charge system includes a vehicle charge coil and a camera system configured to capture calibration images of a primary charge coil at a plurality of positions relative to the primary charge coil. The vehicle battery charge system also includes a controller configured to permit receipt of charge at the vehicle charge coil from the primary charge coil responsive to differences between a present image and a corresponding one of the calibration images being less than a pixel variance threshold.

A method of vehicle battery charging includes indexing a camera through a plurality of positions having a primary charge plate within a field of view and capturing a calibration image at each of the plurality of positions. The method also includes capturing a present image corresponding to at least one of the calibration images prior to initiating a charge procedure. The method further includes outputting an object detection signal responsive to a difference between the calibration image and present image exceeding a detection threshold.

### BRIEF DESCRIPTION OF THE DRAWINGS

FIG. 1 is a diagrammatic view of a vehicle docked at a charging station.

FIG. 2 is a schematic diagram of a camera system arranged for object detection.

FIG. 3 is a flow chart of an algorithm for managing inductive charging including the detection of foreign objects near a charging area.

FIG. 4 is a first image representing a field of view of a camera based object detection system.

FIG. 5 is a second image representing a field of view of a camera based object detection system.

FIG. 6 is a schematic diagram of an alternate example camera system arranged for objection detection.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. The principles of the present disclosure may be implemented using any number of techniques, whether currently known or not. As those of ordinary skill in the art will understand, various features illustrated and described with reference to any one of the figures can be combined with features illustrated in one or more other figures to produce embodiments that are not explicitly illustrated or described. Modifications, additions, or omissions may be made to the systems, apparatuses, and methods described herein without departing from the scope of the disclosure. Such variations of features illustrated may provide other representative embodiments for typical applications, and are consistent with the teachings of this disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps of a method may be performed in any suitable order.

It is not intended that any of the appended claims or claim elements to invoke 35 U.S.C. 112(f) unless the words “means for” or “step for” are explicitly used in the particular claim.

Vehicles can be powered solely by battery electricity (e.g., BEV's) as well as by a combination of power sources including battery electricity. For example hybrid-electric vehicles (HEV's) are contemplated in which the powertrain is powered by both a battery and an internal combustion engine. In these configurations, the battery is rechargeable and a battery charger provides power to restore the battery after discharge.

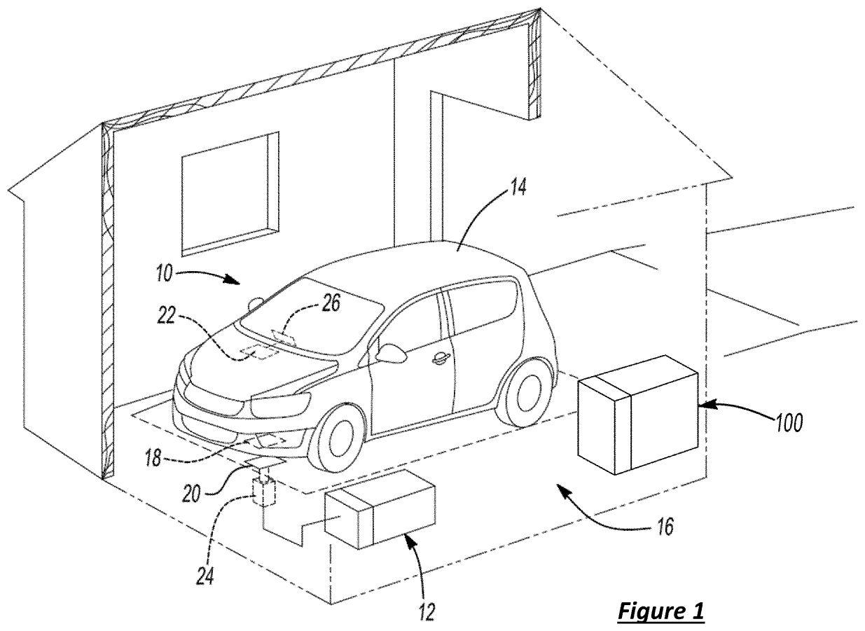

With reference to FIG. 1, a vehicle battery charge system is illustrated generally by referenced numeral 10. Induction battery charging is used to provide power from a charger 12 to a vehicle 14 to restore the battery. A charging station 16 is shown accommodating the vehicle 14 to be charged through induction charging. The vehicle 14 docks at the charging station 16 which houses the charger 12. The charger 12 can be connected to receive household electrical current, such as that available within a typical home garage.

The vehicle 14 includes a secondary coil housed within an induction charge plate 18 disposed on an underside of the vehicle 14. The vehicle secondary induction charge plate 18 is electrically connected to the vehicle battery. The vehicle 14 may also include an alternating current (AC) to direct current (DC) power converter to rectify and filter AC power received from the charger 12 into DC power to be received by the battery. The charger 12 is disposed in the floor beneath the vehicle 14, and includes a primary charging coil housed within a corresponding primary induction charging plate 20. The primary induction charging plate 20 is generally horizontal and positioned at a distance from the vehicle secondary induction charge plate 18. The primary induction charging plate 20 can be articulable in height to create a suitable gap to facilitate charging of the vehicle 14. Electrical current is supplied to the primary coil, which generates an electromagnetic field around the primary induction charging plate 20. In some examples, the top surface of the charge plate defines a charge zone according to the size of the surface and electromagnetic field generated when power is supplied. When the vehicle secondary induction charge plate 18 is in proximate relation to the powered primary induction charging plate 20, it receives power by being within the generated electromagnetic field, or charge zone. Current is induced in the secondary coil and subsequently transferred to the vehicle battery, causing a recharging effect. The gap between the plates allows for variation in vehicle alignment, and also for accommodation of alternate authorized vehicles with differing ride heights.

Vehicle 14 is provided with a controller 22. Although it is shown as a single controller, the vehicle controller 22 can include multiple controllers that are used to control multiple vehicle systems. For example, the vehicle controller 22 can be a vehicle system controller (VSC) that oversees any number of other subsystem controllers. In this regard, the vehicle charging control portion of the VSC can be software embedded within the VSC itself, or it can be a separate hardware device. The vehicle controller 22 generally includes any number of microprocessors, Application Specific Integrated Circuits (ASIC's), integrated circuits (IC's), memory (e.g., FLASH, ROM, RAM, EPROM and/or EEPROM) and software code to co-act with one another to perform vehicle operations. A microprocessor within the vehicle controller 22 further includes a timer to track elapsed time intervals between a time reference and selected events. Designated intervals are programmed such that the controller provides certain commands signals and monitors given inputs at selectable time intervals. The vehicle controller is in electrical communication with the vehicle battery, and receives signals that indicate the battery charge level. The vehicle controller 22 further communicates with other controllers over a hardline vehicle connection using a common bus protocol (e.g., CAN). Controller 22 may also employ wireless communication.

The charger 12 is provided with a charger controller 24 having wireless communication means. The charger controller 24 similarly has embedded software and is programmable to regulate power flow provided by the charger 12. Software included with the charger controller 24 also includes a timer to track elapsed time between designated events. Under selected conditions, or upon the receipt of designated instructions, the charger controller 24 can enable, disable, or reduce power flow through the charger 12. The charger 12 is configured to receive signals indicative of charge instructions from the vehicle controller 22.

The vehicle controller 22 is configured to wirelessly communicate with the charger controller 24. The wireless communication can be accomplished through radio frequency identification (RFID), near field communication (NFC), Bluetooth, or other wireless communication techniques. In at least one example, said wireless communication is used to complete an association procedure between the vehicle 14, and the charger 12 prior to initiating a charge procedure. The association procedure can include the vehicle controller 22 sending one or more signals to the charger controller 24 as part of an authorization procedure. Authorization of power delivery can be influenced by a number of factors including the presence of foreign objects near the charging area, power ratings, security keys, and/or other authentication factors. Based on an appropriate signal from the charger controller 24, the vehicle controller 22 detects the presence of an authorized charger, and may provide an initiation signal to the charger controller 24 to instruct the charge system to initiate a charge procedure. The initial wireless request and subsequent authentication response may be part of an association “handshake” between the vehicle and charging system.

As mentioned above in reference to FIG. 1, there is a gap between the vehicle secondary induction charge plate 18 and the primary induction charging plate 20. Foreign objects may enter the electromagnetic field of charge because of the spacing of the gap. Charge management systems and methods are disclosed herein that include the detection of a foreign object entry into a region proximate to the field of charge, and a subsequent response.

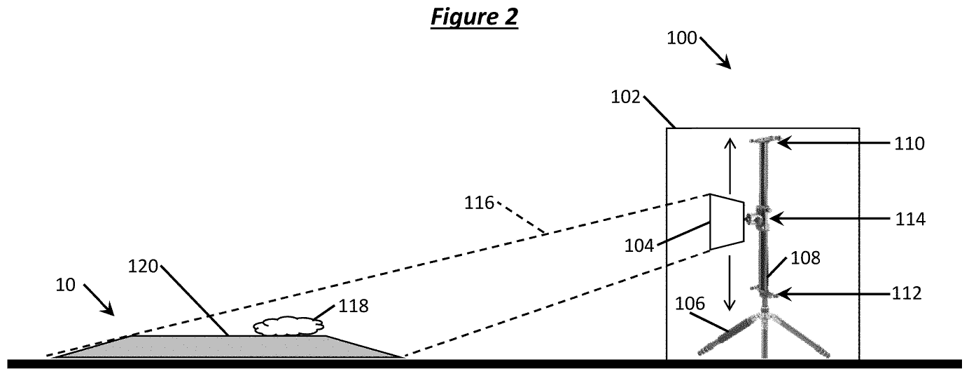

FIG. 2 is a schematic representation of a camera system 100 used on conjunction with the induction charging system described immediately above. The camera system 100 is provided proximate to the parking location to detect objects in the vicinity of the charge plate 120. The camera system 100 may include a housing 102 to protect internal camera components. The camera system 100 also includes a camera 104 that is indexable and arranged to capture images of the charge plate 120. The camera 104 may be mounted to an indexing mechanism 106 that is arranged to vertically adjust the position of the camera 104. According to some examples, the indexing mechanism 106 includes a track portion 108 defining a number of different positions for the camera 104. In a more specific example, the indexing mechanism 106 is configured to index the camera 104 between a plurality of different vertical stations. The track portion 108 allows the camera position to move to any of a plurality of positions between an uppermost location 110 and a lowermost location 112. As shown in FIG. 2, the camera 104 is positioned at an intermediate location 114. The camera 104 is also arranged to have a field of view 116 that captures an image of the charging plate 120. As the vertical position of the camera 104 is changed, the field of view 116 is adjusted to remain pointed at the charge plate 120. As discussed in more detail below, the camera system 100 is adapted to optically detect the presence of a foreign object 118 in a vicinity of the charge plate 120. While the example of FIG. 2 depicts vertical indexing of the camera position, it should be appreciated that changing the position of the camera in other directions may also be suitable. Specifically, the track portion may be arranged to move horizontally, tilt and/or pivot in various directions, or undertake any number of predetermined paths as appropriate.

The vehicle controller is configured to receive output signals from the camera system 100, and use these data to enhance instructions provided to the charger. The camera system monitors the area near the induction plates for intrusion of foreign objects into the charge field. As described above, the charging system is configured to disable charging when a foreign object is detected near the primary induction charge plate.

The camera system may be activated for monitoring prior to charge initiation, as well as during charge procedures. If an object is detected in the vicinity of the induction charge plate, a detection signal is output from the camera system 100 indicating the presence of the object. If no object is detected in the vicinity of the induction charge plate, the camera system 100 may output a clearance signal indicative of no foreign objects near the charge plate. The charger controller is configured to disable the current flow if a detection signal is received from any of the camera system 100. Once charging is disabled, the camera system 100 may continue to monitor the area near the charging plate. If a subsequent clearance signal is received from the object detection system, the vehicle controller 22 is programmable to cause the transmission of a resumption signal to the charger controller 24. The monitoring resumption command may accompany an instruction to resume the battery charge procedure previously disabled by object detection.

Once an object has cleared the vicinity of the charge plate and is no longer detected, the battery charge system 10 is configured to resume a previously-disabled charge procedure. The detection signal transmitted from the camera system 100 can again be used as a means to control the charge procedures conducted by the charger 12. As mentioned above, the camera system may remain active during an interruption of a charge procedure due to object detection. Once a foreign object is no longer detected, a clearance signal is output from the camera system 100. The charger controller 24 causes a resumption of the charge procedure in response to the clearance signal. The charger 12 is thus prompted to resume charging of the battery via the induction charge plate 20.

The vehicle controller 22 is further configured to cause the generation of a plurality of alert signals. Referring back to FIG. 1, the vehicle 14 is provided with a user display 26 inside the passenger compartment. The user display 26 serves as an alert mechanism to an operator. The controller 22 can cause the generation of a number of different in-vehicle display messages. For example, display alerts are generated that notify an operator of a detected object and/or the disablement of a charge procedure. The vehicle horn is an additional alert mechanism capable of providing an external audible alert signal in response to a detected object proximate to the field of charge. The horn alert pulse duration and repetition pattern may be set to be unique to distinguish obstacle detection events from other events which cause horn pulses.

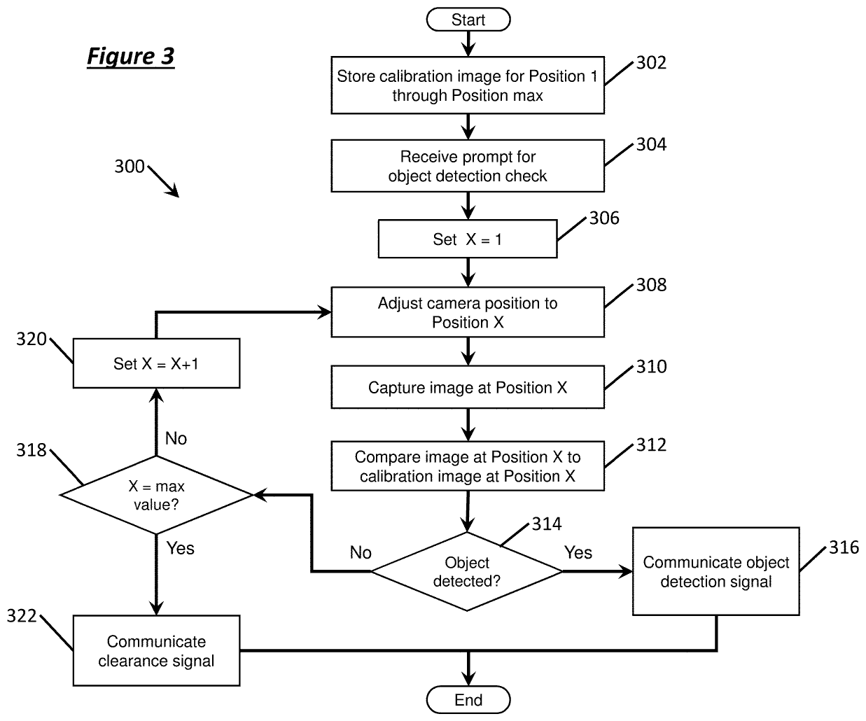

Referring to FIG. 3, a method 300 of detecting objects in a vicinity of the charge plate. At step 302 a calibration image is captured at a plurality of different camera positions. According to some examples, an initial calibration procedure includes capturing an image at each of a range of indexed positions, such as Position₁ through Positionₘₐₓ. Each of the captured images is stored in memory for later retrieval. According to some examples, a plurality of indexed positions is stored in connection with an initialization procedure.

At step 304, the charger controller receives a prompt for an object detection check. In some examples, an object detection check prompt is generated preceding the start of an upcoming charge cycle. In other cases, an object detection prompt is generated at periodic intervals during a charge cycle. In further examples the prompt for an object detection sweep is provided as part of a calibration procedure at the time of installation of the charge system.

The charge controller may store X number of predetermined positions between a Positionₘᵢₙ and the Positionₘₐₓ. At step 306 the value of X is set to X=1, corresponding to the first predetermined position. At step 308 the camera is adjusted to Position_{X}, which in the initial case is Position₁. At step 310 an image is captured via the camera at Position_{X}. The charge controller is further programmed to recall at least one of the stored calibration images corresponding to the current position, Position_{X}. At step 312 the charge controller compares the present image associated with Position_{X} to the stored calibration image associated with Position_{X}. In alternative examples, the camera system is arranged to capture images at predetermined time intervals for one or more camera positions. That is, if there is a sufficient difference between a later image and an earlier image for a particular camera position, the system may be configured to output an object detection signal. The earlier image may be a reference image captured during an initialization procedure, or and image taken earlier in time to which a comparison may be made.

At step 314 the method includes calculating, based on image comparison, whether an object is present in the vicinity of the charge plate. If no object is detected at step 314, the method includes indexing to the next predetermined position having a stored calibration image. At step 318 the method includes determining whether the camera has already been advanced to the maximum position of the available range, Positionₘₐₓ. If the maximum position has not been reached at step 318, the method includes setting the value of X to the next available position location at step 320. That is, the value of X is advanced by 1 increment to be equal to X+1. The method further includes returning to step 308 to advance the camera position to the next position according to the updated value of X.

Similar to the steps discussed above, the method includes capturing a present image associated with the updated Position_{X} at step 310, then comparing the image to the calibration image associated with the updated Position_{X} at step 312. If once again no object is detected at step 314, the method includes incrementally advancing the camera position through the remaining available range of predetermined camera positions. Once all positions have been exhausted with no object detected, the value of X has reached a maximum value. If at step 318 X equals the maximum value, the method includes communicating a clearance signal at step 322. The clearance signal may be transmitted to the charge system, and be used as part of an authorization to commence a charge cycle. In some alternative examples, the clearance signal includes one or more visual indicators to inform a user that the charge plate is clear.

If an object is detected at step 314 through an image comparison at any of the positions, the method includes generating an object detection signal at step 316. The object detection signal may be generated in response to the difference between the calibration image and the corresponding present image for at least one position exceeding a detection threshold. The detection signal may be similarly transmitted to the charge system and used as part of an authorization procedure to prevent the initiation of a charge procedure while the object is detected as being in the vicinity of the charge plate. In some other examples, the detection signal includes one or more visual indicators to inform a user that the charge plate is obstructed. In a more specific example a light indicator is displayed in the area of the parking location to inform users of the status of the charging plate. In other specific examples, the detection signal is transmitted to an incoming vehicle and a visual indicator is provided at a user display to inform the driver of the status of the charging plate.

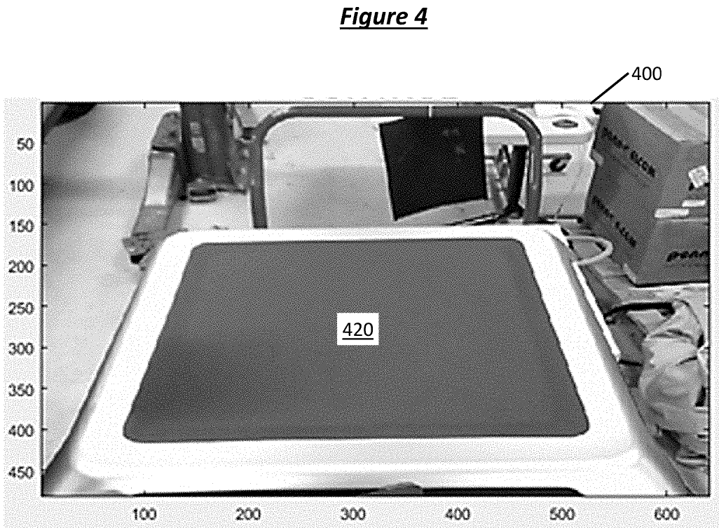

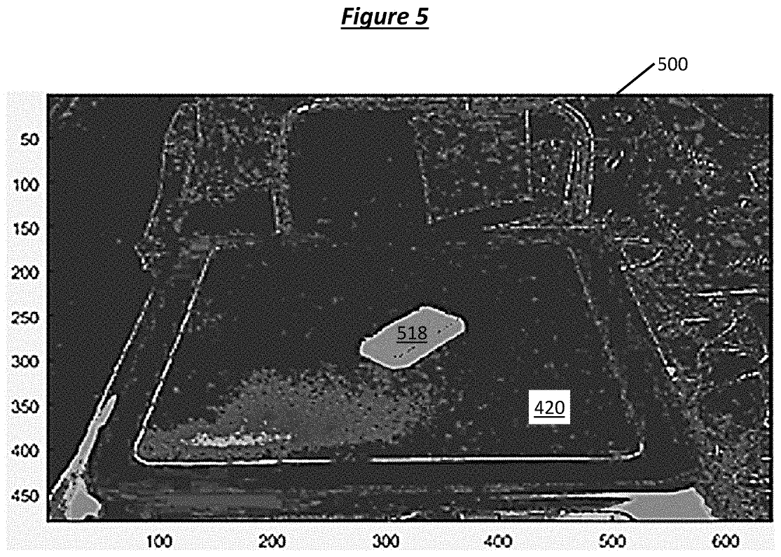

Referring to FIG. 4 and FIG. 5, an example image comparison is provided. FIG. 4 represents a digital calibration image 400 for a given camera position. The calibration image 400 includes a charge plate 420 within the field of view of the camera. As depicted in the image of FIG. 4, the charging plate 420 is in a clear state having no obstructions or other objects in the close vicinity of the plate.

FIG. 5 represents the output of an image comparison analysis. FIG. 5 includes comparison image 500 that visually represents a comparison of the calibration image 400 to a later-captured digital image of an obstruction on the charging plate 420. According to some examples, a pixel-by-pixel comparison is performed between the calibration image and the later-captured present image. For those pixels exhibiting no difference as a result of the comparison, darker shading is applied to the comparison image 500. In contrast, for those pixels exhibiting a difference relative to the calibration image greater than a difference threshold, a lighter color is applied to the comparison image 500 to highlight the presence of a foreign object. In the example of FIG. 5, foreign object 518, a cellular phone, is highlighted in the image. If the number of pixels highlighted in the comparison image is greater than a pixel count threshold, an object detection signal may be generated as discussed above. In further examples the charger controller may be programmed to output a comparison image including the charge zone at a user display in response to the object detection signal. The user display may be the vehicle user display discuss above, or alternatively a display located elsewhere to inform a user, such as mounted near the parking port.

Referring to FIG. 6, a second example camera system 600 is mounted to an electrified vehicle 602 that is compatible with the charge system 10. The camera system 600 is provided at a leading end of the vehicle 602 to detect objects in the vicinity of the charge plate 120. The camera system 600 includes at least one camera 604 arranged to capture images of the charge plate 120 as the vehicle is docking at the charge system 10. As the vehicle approaches a final position for charging, the camera is progressed through a plurality of different horizontal stations. The vehicle may store a predetermined first position 610 at which the camera system 600 may acquire a first image. The vehicle may also store a predetermined second position 612 at which the charging plate 120 becomes outside of the field of view 616 of the camera 604. Each of the first position 610 and the second position 612 may be determined and stored as part of a calibration initialization procedure. Similar to examples discussed above, a calibration image is stored and associated with each of a plurality of positions between the first position 610 and the second position 612. As shown in FIG. 6, the camera 604 is depicted as positioned at an intermediate location 614.

Upon subsequent docking of the vehicle 602 toward the charge system, the camera system 600 is activated in response to the vehicle passing through the first position 610 to acquire a first present image. The camera system 600 is configured to compare the first present image to the previously-stored calibration image associated with the first position 610. If no object is detected, the camera system may output a clearance signal as discussed above. As the vehicle 602 is progressed further toward a final charging position, the camera system 600 is prompted to capture a second present image corresponding to a previously-stored second calibration image. Once again if no object is detected by the camera system 600 the clearance signal is continually provided. In contrast, if a foreign object 118 is detected within the field of view 616 of the camera 604, the camera system 600 outputs an object detection signal to inform the driver of the presence of the foreign object 118. The camera system 600 may be configured to capture at least one present image as part of a vehicle docking procedure. Additionally, the camera system 600 may be configured to output a signal to the charge system 10 in response to detection of a foreign object to prevent power delivery from the charge plate.

While approaching a final charge position of the vehicle, the camera system 600 continues to capture a present image each time the vehicle passes through a predetermined position having a corresponding calibration image. Once the vehicle 602 reaches the second position 612 without detection of any foreign objects, the object detection routine may be concluded, and a final clearance signal output to the charging system 10 as part of a charge authorization procedure.

The processes, methods, or algorithms disclosed herein can be deliverable to/implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A vehicle comprising:
a charge plate configured to receive charge for a battery when positioned at a charge zone;
a camera system; and
a controller programmed to
cause the camera system to capture a calibration image at each of a plurality of indexed positions as the charge plate approaches the charge zone,
cause the camera system to capture a present image for at least one of the indexed positions, and
prevent initiation of a charge procedure responsive to differences between the present image and a corresponding one of the calibration images exceeding a pixel variance threshold.

2. The vehicle of claim 1, wherein each of the plurality of indexed positions is stored in connection with an initialization procedure.

3. The vehicle of claim 1 wherein the present image is captured as part of a vehicle docking procedure.

4. The vehicle of claim 1 wherein the differences between the present image and the corresponding calibration image are derived from a pixel-by-pixel comparison.

5. The vehicle of claim 4 wherein the controller is further programmed to output a comparison image including the charge zone at a user display.

6. The vehicle of claim 5, wherein the comparison image includes a highlighting of pixels exceeding the pixel variance threshold.

7. A vehicle battery charge system comprising:
a vehicle charge coil;
a camera system configured to capture calibration images of a primary charge coil at a plurality of positions relative to the primary charge coil; and
a controller configured to permit receipt of charge at the vehicle charge coil from the primary charge coil responsive to differences between a present image and a corresponding one of the calibration images being less than a pixel variance threshold.

8. The vehicle battery charge system of claim 7 wherein the camera system is further configured to initiate the capture at least one calibration image during an initialization procedure.

9. The vehicle battery charge system of claim 7 wherein the controller is further configured to prevent receipt of charge at the vehicle charge coil responsive to the differences exceeding the pixel variance threshold.

10. The vehicle battery charge system of claim 7 wherein the controller is further configured to capture the present image responsive to initiation of a vehicle docking procedure.

11. The vehicle battery charge system of claim 7 further comprising a user display to output a comparison image of the primary charge coil derived from a pixel-by-pixel comparison of the present image and the corresponding one of the calibration images.

12. The vehicle battery charge system of claim 7 further comprising generating an object detection signal responsive to the differences exceeding the pixel variance threshold.

13. A method of vehicle battery charging comprising:
indexing a camera through multiple positions having a primary charge plate within a field of view;
capturing a calibration image at each of the multiple positions;
prior to initiating a charge procedure, capturing a present image corresponding to at least one of the calibration images; and
outputting an object detection signal responsive to a difference between the calibration image and present image exceeding a detection threshold.

14. The method of claim 13 wherein the capturing of a calibration image is performed as part of an initialization procedure.

15. The method of claim 13 wherein the capturing of a present image is performed as part of a vehicle docking procedure.

16. The method of claim 13 further comprising outputting a comparison image at a user display responsive to the object detection signal, wherein the comparison image is indicative of a pixel-by-pixel comparison between the at least one calibration image and the corresponding present image.

17. The method of claim 16 further comprising highlighting pixels of the comparison image exhibiting a difference relative to the calibration image exceeding a pixel variance threshold.

18. The method of claim 13 further comprising preventing initiation of the charge procedure responsive to the object detection signal.
